(19) United States
(12) Patent Application Publication
(10) Pub. No.: US 2023/0360391 A1
(43) Pub. Date: Nov. 9, 2023

(54) SYSTEMS AND METHODS FOR USE IN IMAGE PROCESSING RELATED TO POLLEN VIABILITY

(71) Applicant: Monsanto Technology LLC, Saint Louis, MO (US)

(72) Inventors: Jason D. Licamele, Tucson, AZ (US); Frederico Pereira Ribeiro, Rhone (FR); Anju Panicker Madhusoodhanan Sathik, Chesterfield, MO (US)

(21) Appl. No.: 18/142,493

(22) Filed: May 2, 2023

Related U.S. Application Data
(60) Provisional application No. 63/337,999, filed on May 3, 2022.

(51) Int. Cl. G06V 20/10; G06V 10/764; G06V 10/94; G06V 10/82; H04N 23/51; H04N 23/56

(52) U.S. Cl. CPC G06V 20/188; G06V 10/764; G06V 10/95; G06V 10/82; H04N 23/51; H04N 23/56

(57) ABSTRACT

Systems and methods are provided for use in determining viability of pollen, through image processing. One example computer-implemented method includes capturing, by a pollen imaging apparatus, an image of pollen disposed on a platform of the pollen imaging apparatus and classifying, by a computing device, coupled to the pollen imaging apparatus, pollen included in the captured image into one of multiple classes based on a classifier defining a feature pyramid network. The method also includes determining one or more metrics associated with the one or more classes of pollen included in the image and providing, to a user, an indication of viability of the pollen based on whether the one or more metrics satisfy a defined threshold, thereby instructing the user in the viability of the pollen included in the image.

### CROSS-REFERENCE TO RELATED APPLICATION

This application claims the benefit of, and priority to, U.S. Provisional Application No. 63/337,999, filed May 3, 2022, the entire contents of which are hereby incorporated by reference.

### FIELD

The present disclosure generally relates to systems and methods for use in evaluating pollen quality (e.g., viability, etc.) of pollen grains, and in particular, to systems and methods for use in processing images of such pollen grains to assess their shape and, based thereon (at least in part), determine viability of the pollen grains for use in plant breeding.

### BACKGROUND

This section provides background information related to the present disclosure which is not necessarily prior art.

It is known for seeds to be grown by growers in fields for commercial purposes, whereby the resulting plants, or parts thereof, are sold by the growers. In connection therewith, plant breeders are known to breed and/or advance different varieties of plants, through various techniques, whereby performance of the plants is enhanced in later generations of the plants, as to, for example, drought tolerance, disease resistance, yield, etc. The plants are then distributed, as seeds, for example, to growers for planting in the fields, whereby the growers reap the benefit of the enhancements.

### SUMMARY

This section provides a general summary of the disclosure, and is not a comprehensive disclosure of its full scope or all of its features.

Example embodiments of the present disclosure generally relate to determining viability of pollen, through image processing and computer vision techniques.

In one example embodiment, a computer-implemented method for use in determining viability of pollen, through image processing, generally includes: (a) capturing, by a pollen imaging apparatus, an image of pollen disposed on a platform of the pollen imaging apparatus; (b) classifying, by a computing device, coupled to the pollen imaging apparatus, pollen included in the captured image into one of multiple classes, based on a classifier defining a feature pyramid network; (c) determining, by the computing device, one or more metrics associated with the one or more classes of pollen included in the image; and (d) providing, by the computing device, to a user, an indication of viability of the pollen based on whether the one or more metrics satisfy a defined threshold, thereby instructing the user in the viability of the pollen included in the image.

In another example embodiment, a non-transitory computer-readable storage medium including executable instructions for determining viability of pollen, which when executed by at least one processor, generally cause the at least one processor to: (a) receive at least one image of pollen from a pollen imaging apparatus, whereby the at least one image includes an image of the pollen disposed on a platform of the pollen imaging apparatus; (b) classify pollen included in the received at least one image into one of multiple classes, based on a classifier defining a feature pyramid network; (c) determine one or more metrics associated with the one or more classes of pollen included in the at least one image; and (d) provide, to a user, an indication of viability of the pollen based on whether the one or more metrics satisfy a defined threshold, thereby instructing the user in the viability of the pollen included in the at least one image.

In another example embodiment, a system for use in determining viability of pollen, through image processing, generally includes at least one computing device configured to: (a) receive an image of pollen from a pollen imaging apparatus, whereby the image includes an image of the pollen disposed on a platform of the pollen imaging apparatus; (b) classify pollen included in the received image into one of multiple classes, based on a classifier defining a feature pyramid network; (c) determine one or more metrics associated with the one or more classes of pollen included in the image; and (d) provide, to a user, an indication of viability of the pollen based on whether the one or more metrics satisfy a defined threshold, thereby instructing the user in the viability of the pollen included in the image.

In another example embodiment, a pollen imaging apparatus for use in determining viability of pollen, through image processing, generally includes: (a) a platform configured to support pollen in the pollen imaging apparatus; (b) an enclosure, which cooperates with the platform to inhibit ambient light from the pollen disposed on the platform; (c) an image capture device configured to capture the image of the pollen disposed on the platform of the pollen imaging apparatus; (d) a light fixture configured to illuminate the pollen on the platform of the pollen imaging apparatus, when the image capture device captures the image of the pollen; and (e) a network interface configured to receive instructions for capturing the image and/or configured to transmit the captured image to at least one computing device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates an example system of the present disclosure suitable for use in determining viability of pollen (e.g., of pollen grains, etc.) through image processing;

FIG. 1B illustrates detail of an example architecture of a classifier that may be used in the system of FIG. 1A;

FIG. 2 illustrates an example image of grains of pollen, disposed on a platform, as captured through the system of FIG. 1A;

FIG. 3 is a block diagram of an example computing device that may be used in the system of FIG. 1A; and

FIG. 4 illustrates an example method, which may be implemented in connection with the system of FIG. 1A, for use in determining viability of pollen (e.g., of pollen grains, etc.), through image processing, prior to use of the pollen in a pollination process (e.g., in a plant breeding pipeline in connection with plant advancement, etc.).

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In pollination, pollen grains are transferred from male anthers of plants (e.g., of flowers of the plants, etc.) to female stigmas (e.g., of flowers of the plants or other plants, etc.). The plants may be capable of self-pollination, cross-pollination, or both. Self-pollination involves the transfer of pollen from male anthers of plants (e.g., of flowers of the plants, etc.) to female stigmas of the same plants (e.g., of flowers of the same plants, etc.). And, cross-pollination involves the transfer of pollen from male anthers of plants (e.g., of flowers of the plants, etc.) to female stigmas of different plants (e.g., of flowers of different plants, etc.) (e.g., plants from a different family, line, etc.). In this way, the plants are able to create offspring in the form of seeds, which contain genetic information to produce new plants. However, the seeds can only be produced when the transferred pollen grains are of suitable quality (e.g., are viable, etc.).

In connection with plant advancement, it may be required to pollinate different plants, with specific pollen, in order to create a desired combination of different traits in the plants and/or desired varieties of the plants, etc. Pollen (e.g., pollen grains, etc.), therefore, may be collected from a specific plant, at a specific time, and then applied and/or exposed to a same or a different plant. In various breeding environments, the pollen may be exposed to a variety of environmental conditions, from moisture content to temperature, etc., that impact the viability of the pollen. The viability of the pollen is generally assumed based on the environmental conditions (e.g., defined, based on prior determinations, etc. for different environments; etc.), and timing of the pollen, whereby the pollen is collected and applied at certain times of day, etc. based on such assumptions. The assumptions, however, may not always accurately gauge the specific viability of the pollen (or individual pollen grains), for instance, taking into account climate changes in fields, etc., whereby pollen, which is not viable, may still unknowingly be used.

Uniquely, the systems and methods herein provide for determining viability of pollen (e.g., individual grains of the pollen, etc.), based on image processing thereof, where, for example, shape(s) of the grains of the pollen (e.g., individual grains of the pollen, etc.) provides an indicator of the viability of the pollen (e.g., a sample of the pollen including the imaged grains, etc.). As such, in some embodiments, the systems and methods herein provide for flexibility in determining viability of pollen, for instance, when weather and/or climate changes in fields, etc., to still provide true, accurate, usable, etc. representations of viability for the pollen. In addition, in some embodiments, the systems and methods herein also provide for improved determinations of viability of pollen in connection with growing various germplasms in controlled environments. As such, and as generally described herein, the systems and methods herein may be used to evaluate pollen viability at a time prior to an expected pollination window to make sure (or to provide confidence) that pollinating activities are taking place at an appropriate time (e.g., a desired time based on viability of the pollen, an optimal pollination time, etc.), regardless of germplasm, shifting environmental conditions, etc. In other words, the systems and methods herein may provide a tool to identify a particular time to start pollinations and end pollinations, and then enable, facilitate, cause, etc. implementation of such pollinations based the identified time(s).

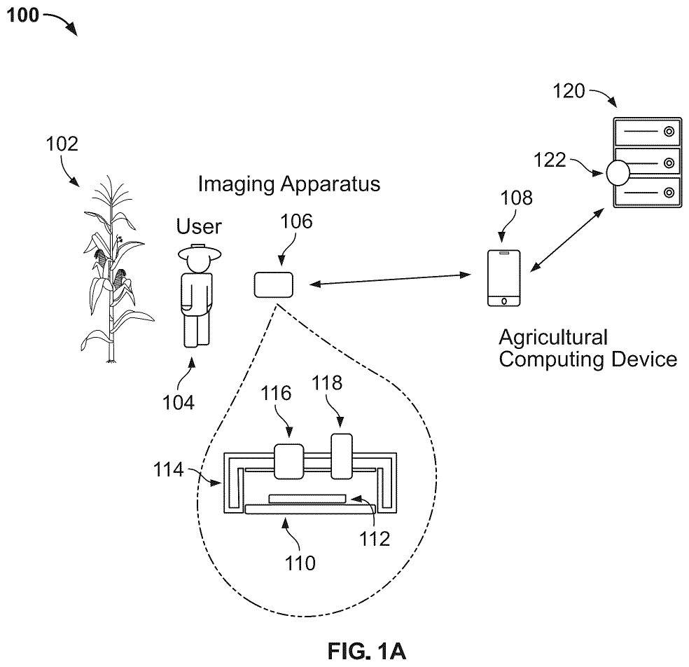

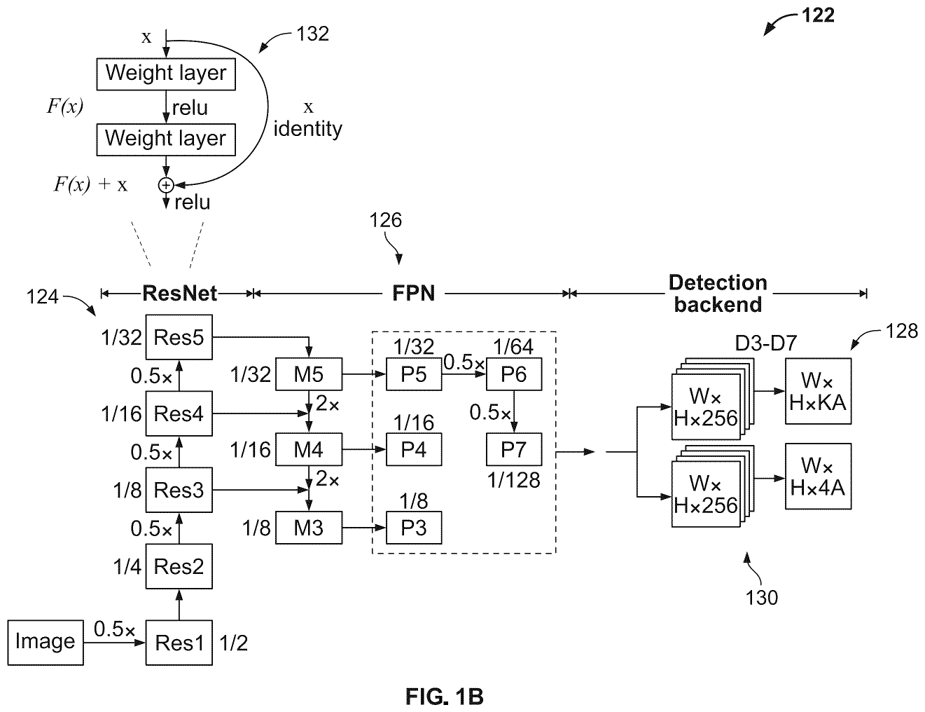

FIG. 1A illustrates an example system 100 in which one or more aspects of the present disclosure may be implemented. Although the system 100 is presented in one arrangement, other embodiments may include the parts of the system 100 (or other parts) arranged otherwise depending on, for example, specific pollination processes; types, sizes and/or conditions of plants and/or growing spaces of the system 100; types and/or varieties of pollen; etc.

The illustrated system 100 generally includes a plant 102 (or multiple such plants 102 or multiple plants in general (either the same or different)) disposed in a growing space (e.g., a green house, a field, etc.), and a user 104 (e.g., a grower, a technician, a scientist, another user, etc.) associated with the plant 102. The user 104, for example, is present to conduct and/or perform certain tasks related to pollination of the plant 102 and/or collecting pollen (e.g., pollen grains, etc.) from the plant 102. In particular, in this example, at a certain growth stage of the plant 102, the user 104 acts to collect pollen from tassels of the plant 102, as a male hybrid, for example, through a pollen collection device (e.g., a cup, a paper collector, a pollen bag, etc.) placed over the tassels of the plant 102, etc. The pollen may be collected in various seasons, times of day, etc., as desired and/or appropriate given the particular type of the plant 102 and/or pollen associated therewith, the particular growing space and/or the availability of the user 104. In addition, the system 100 may be configured to filter anthers out from the collected pollen, and also clumped pollen, to help provide for improved accuracy in the viability assessment of the pollen (e.g., physically as part of sample preparation of the collected pollen, via analysis of images of the samples of the collected pollen, etc.).

That said, the plant 102 may include, for example (and without limitation), one or more of Arabidopsis, Brachypodium, switchgrass, rose, sunflower, bananas, opo, pumpkins, squash, lettuce, cabbage, oak trees, guzmania, geraniums, hibiscus, clematis, poinsettias, sugarcane, taro, duck weed, pine trees, Kentucky blue grass, zoysia, coconut trees, cauliflower, cavalo, collards, kale, kohlrabi, mustard greens, rape greens, and other brassica leafy vegetable crops, bulb vegetables (e.g., garlic, leek, onion (dry bulb, green, and Welch), shallot, etc.), citrus fruits (e.g., grapefruit, lemon, lime, orange, tangerine, citrus hybrids, pummelo, etc.), cucurbit vegetables (e.g., cucumber, citron melon, edible gourds, gherkin, muskmelons (including hybrids and/or cultivars of cucumis melons), water-melon, cantaloupe, and other cucurbit vegetable crops), fruiting vegetables (including eggplant, ground cherry, pepino, pepper, tomato, tomatillo), grape, leafy vegetables (e.g., romaine, etc.), root/tuber vegetables (e.g., potato, etc.), and tree nuts (almond, pecan, pistachio, and walnut), berries (e.g., tomatoes, barberries, currants, elderberries, gooseberries, honeysuckles, mayapples, nannyberries, Oregon-grapes, see-buckthoms, hackberries, bearberries, lingonberries, strawberries, sea grapes, blackberries, cloudberries, loganberries, raspberries, salmonberries, thimbleberries, and wineberries, etc.), cereal crops (e.g., corn (maize), rice, wheat, barley, sorghum, millets, oats, ryes, triticales, buckwheats, fonio, quinoa, oil palm, etc.), Brassicaceae family plants, Fabaceae family plants, pome fruit (e.g., apples, pears), stone fruits (e.g., coffees, jujubes, mangos, olives, coconuts, oil palms, pistachios, almonds, apricots, cherries, damsons, nectarines, peaches and plums, etc.), vine (e.g., table grapes, wine grapes, etc.), fiber crops (e.g. hemp, cotton, etc.), ornamentals, beans (e.g., Tarbais beans, Preisgewinner beans, etc.), alfalfa, and the like.

In this example embodiment, the system 100 also includes a pollen imaging apparatus 106 and an agricultural computing device 108, which is coupled to the pollen imaging apparatus 106. The pollen imaging apparatus 106 may be coupled to the computing device 108 directly via a wired connection or via a wireless connection (e.g., NFC, Bluetooth, etc.), or indirectly through one or more networks. In the latter, the network(s) may include one or more of, without limitation, a local area network (LAN), a wide area network (WAN) (e.g., the Internet, etc.), a mobile network, a virtual network, and/or another suitable public and/or private network capable of supporting communication among parts illustrated in FIG. 1A, or any combination thereof.

With respect to the user 104, once again, the pollen collected from the plant 102 may be directly applied to another plant, immediately upon collection (e.g., within about one hour, within about 2 hours, within about 6 hours, within about 12 hours, within about 24 hours, etc.), or at some later time. In connection therewith, it should be appreciated that the pollen may be viable or not, depending on, for example, a moisture content of the pollen, or other characteristics of the pollen, or other environmental factors to which the pollen is exposed, etc. As such, in one or more embodiments, the user 104 may desire to assess the viability of the collected pollen prior to using the pollen in further breeding activity, or more generally, prior to using the pollen in pollination processes for one or more plants.

Considering the above, if the pollen is to be applied at a later time, it may be stored prior to such application to another plant. In doing so, the pollen may be stored following viability analysis herein (e.g., viability of the pollen may be assessed following collection and prior to storage, etc.). Additionally, when stored following viability analysis, the pollen may be analyzed again during storage and/or after storage for viability, for example, prior to application to another plant. Further, such storage of the collected pollen may include short-term storage (e.g., at least about one day, at least about 5 days, at least about 10 days, at least about 15 days, up to about 21 days, from about one day up to about 21 days, etc.) or long-term storage (e.g., about 21 days or more, about 3 months or more, about 6 months or more, about one year or more, about 2 years or more, about 3 years or more, etc.).

In this example, upon collecting the pollen (or a sample thereof), the user 104 includes the pollen (e.g., grains of the pollen, etc.) in (or provides the pollen to) the pollen imaging apparatus 106. In doing so, the user 104 may provide all of the collected pollen to the imaging apparatus 106, or the user 104 may provide a representative sample of the collected pollen. In some example embodiments, the collected pollen may be processed (e.g., by the user 104, etc.) prior to being introduced to (or in) the pollen imaging apparatus. For instance, the collected pollen may be filtered to remove anthers, clumped pollen, other debris, etc.

The illustrated pollen imaging apparatus 106 includes a platform 110, which is configured to support the pollen received from (or provided by) the user 104 (or from another automated feeding device configured to provide the pollen to the platform 110, etc.), where the pollen is schematically shown and referenced 112 in FIG. 1A. The platform 110, in this example embodiment, defines a color in contrast with the color of pollen 112 (to thereby enable capture of images of the pollen suitable for analysis herein). For example, where the pollen 112 is whitish, or yellowish, the background platform 110 may define a black or relatively darker color to contrast the pollen supported thereon. In addition, the platform 110 may have a gloss finish, semi-gloss finish, or a matte finish, etc., depending on the particular imaging implementation and/or the particular type of the pollen 112 (e.g., the type of the plant 102 from which the pollen 112 is collected, etc.). The platform 110 may also be made from various materials, which may be coated or not with various materials. In this example embodiment (and without limitation), the platform 110 includes a gloss, black acrylic board. Other platform materials may include particle board, rubber, construction paper, or other contrasted materials that may be smooth and/or scratch resistant, etc. That said, in various embodiments, the material used to construct the platform 110 may be any desired material, and a color and/or shading of the material (and, thus, the platform 110) provides a background that enables capture of images suitable for analysis herein.

Additionally, the pollen imaging apparatus 106 includes an enclosure 114, which is configured to cooperate with the platform 110 to enclose (wholly or at least partially) the pollen 112 supported by the platform 110. In this manner, the enclosure 114 is configured to limit exposure of the pollen 112, when positioned on the platform 110 in the enclosure 114, to ambient light. As such, for various embodiments, the enclosure 114, or at least the internal surface of the enclosure 114, may include a coating, a shape and/or a color consistent with that of the platform 110 (e.g., a black acrylic board material, etc.), whereby ambient light is limited, and the surface responds consistent with the platform 110. It should further be appreciated that the platform 110 and the enclosure 114 may be (or may define) any suitable size and/or shape, depending on, for example, a quantity of pollen (e.g., a number of pollen grains, etc.) to be included in the pollen imaging apparatus at one time, etc.

That said, the amount/size of pollen (e.g., quantity of pollen grains, etc.) provided to the pollen imaging apparatus 106 may include any suitable amount/size, for example, as desired by the user 104, as can be accommodated by the imaging apparatus 106 (e.g., the platform 110 thereof, etc.), etc. For example (and without limitation), in one example, the amount/size of pollen provided to the imaging apparatus 106 may be about 10 pollen grains or more, about 100 pollen grains or more, about 300 pollen grains or more, about 400 pollen grains or more, between about 100 pollen grains and about 400 pollen grains, about 300 pollen grains, about 1000 pollen grains or more, etc. In addition, in some examples, a sample of pollen may be divided into subsamples (e.g., two subsamples, three subsamples, four subsamples, five subsamples, more than five subsamples, etc.), and each subsample may then be provided (e.g., sequentially, etc.) to the imaging apparatus 106 (where each subsample may have an amount/size of pollen as described herein). In other examples, the amount/size of pollen (or sample relating thereto and/or including the pollen) provided to the imaging apparatus 106 may be at least about 0.005 mL, at least about 0.01 mL, at least about 0.02 mL, at least about 0.05 mL, at least about 0.1 mL, at least about 1 mL, at least about 5 mL, at least about 10 mL, between about 0.02 mL and about 10 mL, about 0.04 mL, at least about 20 mL, more than 20 mL, etc.

In some example embodiments, the pollen may be provided to the imaging apparatus in germ plates, where the germ plates are then positioned on the platform 110. Further, in some example embodiments, the platform 110 may include a germination media (e.g., a germination media formed as a film on the platform 110, a germination media film positioned on the platform 110 (e.g., as a film/layer, as part of another component that may then be positioned on the platform 110, etc.), etc.). In connection therewith, the germination media may include a liquid germination media, a semi-solid germination media, an agar-based media, and/or other germination media, etc. In such embodiments, germination of the pollen in the germination media (e.g., in the plates, in the media on/associated with the platform 110, etc.) may be viewed over time via the pollen imaging apparatus 106.

With continued reference to FIG. 1A, the enclosure 114 includes a light fixture 116 and an image capture device 118 supported by the enclosure 114. The light fixture 116 is configured as, or includes, a light source for illuminating the pollen 112 within the enclosure 114 in connection with capturing an image (or images) of the pollen 112 (e.g., the grains of the pollen 112 on the platform 110 in the enclosure 114, etc.). The light source, then, is configured to provide contrast to the pollen 112 within the enclosure 114, with regard to the platform 110, for example, so that the pollen 112 may be distinguished from the platform 110 in connection with capturing images thereof. The light fixture 116 (and/or corresponding light source) may include any desired light for illuminating the pollen 112 within the enclosure 114 including, for example, light from incandescence light sources (e.g., lamps, bulbs, etc.), light from luminescence light sources (e.g., light emitting diodes (LEDs), etc.), etc.

In one example embodiment (and without limitation), the light fixture may be configured as (or with) a light source that discharges light with the example characteristics identified in Table 1 and/or Table 2. In connection therewith, repeatable settings for the light source may be adapted, used, etc. for facilitating consistency in captured images (e.g., consistency in contrast between the pollen within the enclosure 114 and the platform 110 of the enclosure across the different captured images, etc.).

TABLE 1

| Measure | Value (μmol m⁻²s⁻¹) |
|---|---|
| photosynthetic photon flux density (PPFD) | 64.01 |
| photon flux density (PFD) | 65.38 |
| photon flux density - ultraviolet (PFD-UV) | 0.07 |
| photon flux density - blue (PFD-B) | 21.57 |
| photon flux density - green (PFD-G) | 30.44 |
| photon flux density - red (PFD-R) | 12.42 |
| photon flux density - far-red (PFD-FR) | 1.34 |

TABLE 2

| Measure | Value (%) |
|---|---|
| PFD-UV | 0.10 |
| PFD-B | 32.76 |
| PFD-G | 46.23 |
| PFD-R | 18.87 |
| PFD-FR | 2.03 |

The image capture device 118 generally includes a camera input device (or multiple camera input devices). The image capture device 118 is positioned generally opposite the platform 110, whereby the image capture device 118 is configured to capture an image of the pollen, supported by the platform 110 and illuminated by the light fixture 116. The image capture device 118 may include any suitable device configured to capture images of the pollen 112 (e.g., a color camera input device, an X-ray camera input device, a black-and-white camera input device, in infrared (IR) camera input device, an NRM camera input device, a combination thereof, etc.). What's more, the images captured by the image capture device 118 may include two-dimensional images or three-dimensional images, etc. In various embodiments, the imaging apparatus 106 may include a portable imaging apparatus 106 to allow for usability of the apparatus 106 across multiple different locations (with generally consistent use of the apparatus 106 independent of the location and/or surrounding environment, etc.). In connection therewith, then, the image capture device 118 of the apparatus 106 may include (or may be of a type that is) a portable image capture device (e.g., portable in nature, etc.) and that us therefore usable with the apparatus 106 at the various different locations.

That said, apart from variations in the platform 110, the enclosure 114, the light fixture 116, and the image capture device 118, it should be appreciated that other techniques may be involved to improve and/or impact contrast of the pollen in connection with capturing images thereof. For example, a stain or dye such as cellular adenosine triphosphate, fluorescent staining, etc., may be used to dye the pollen to promote visual contrast and/or identify metabolic activity, etc. (whereby, in addition, a particular light source for the light fixture 116 and/or a particular image capture device 118 may be used and/or selected for use based on the particular dye, for example, to provide sufficient contrast to capture images of the pollen, etc.).

In operation of the system 100, after collecting pollen from the plant 102, the user 104 provides the pollen (or a representative sample thereof) to the imaging apparatus 106. The collected pollen may be provided to the imaging apparatus 106 generally immediately following collection of the pollen (e.g., within about five minutes, within about ten minutes, within about thirty minutes, within about one hour, within about three hours, etc.), or it may be done at a later time (e.g., within about one day, within about one week, within about one year, etc.). In providing the pollen to the imaging apparatus, the user 104 positions the pollen (e.g., a desired amount of the pollen as generally described above, etc.) on the platform 110 of the imaging apparatus 106. In some examples, once the pollen is positioned on the platform 110, the user 104 may brush the pollen (or otherwise cause manipulation of the pollen) so that the pollen is arranged generally in a single layer on the platform 110 (e.g., in a generally single layer of pollen grains, etc.). In some embodiments, an automatic feeder (e.g., an automated feeder system or apparatus, etc.) may be used to provide the pollen to the imaging apparatus 106, for example, where the automatic feeder is configured to provide a desired amount, quantity, etc. of the pollen to the imaging apparatus 106. In any case, in various embodiments the pollen 112 is thus positioned generally stationary on the platform 110 for and during image capture (e.g., the pollen 112 is not flowing across the platform and/or through the enclosure 114 (e.g., the apparatus 106 thus may not include means (e.g., pumps, other devices, etc.) for causing flow of the pollen 112 through the enclosure 114, etc.), etc.). As can be appreciated, this feature of the imaging apparatus 106 may allow for portability of the apparatus and reproducible capture of pollen images.

The pollen imaging apparatus 106 is configured to then capture an image (or images) of the pollen, on the platform 110, and to communicate the image(s) to the computing device 108 (via communication therebetween as described above, etc.). The pollen imaging apparatus 106 may be configured, as such, in response to an input from the user 104, or other input indicative of the pollen being arranged to be imaged thereby, etc. In some examples, the imagine capture device 118 of the pollen imaging apparatus 106 may be configured to capture multiple images of the pollen (e.g., three images, four images, five images, ten images, more than ten images, etc.) as part of the image capture operation.

In turn, the computing device 108 is configured to receive the image(s) from the pollen imaging apparatus 106, to store the image(s) in one or more memories therein, and to determine a viability of the pollen included in the image(s). Alternatively, in some example embodiments, the pollen imaging apparatus 106 may be configured to store the image(s) in one or more memories therein, and to determine a viability of the pollen included in the image(s) (in generally the same manner described herein with regard to the computing device 108 and/or the database 120) and then communicate such determined viability with the computing device 108 and/or the database 120.

In particular in this example embodiment, the computing device 108 includes a classifier, which configures the computing device 108 to identify the viability of the pollen included in the image(s) (e.g., of grains of the pollen included in the image(s), etc.). Specifically, in a training phase, various images of pollen (e.g., of grains of the pollen, etc.) are captured and collected (e.g., through the pollen imaging apparatus 106, etc.). The images are manually inspected, and the pollen within the images may be classified into one of the following example classes: good, intermediate or bad (or into other suitable designations). In connection therewith, for example, the good pollen includes fresh pollen that is likely to geminate. Grains of good pollen may generally define a large round size with a bulgy, inflated ball and/or grape looking structure/shape, and may have a reflectively milky-white or yellow-green color. The intermediate pollen includes pollen that is dehydrated, but may still germinate. Grains of intermediate pollen may generally define a medium irregular size with a deflated ball/asymmetric structure/shape, and may have a light to dark color (relatively). The bad pollen, in contrast, is not expected to germinate. Grains of bad pollen may define generally a small irregular size with a deflated ball/asymmetric structure/shape, and may have a non-reflective, dark yellow edges.

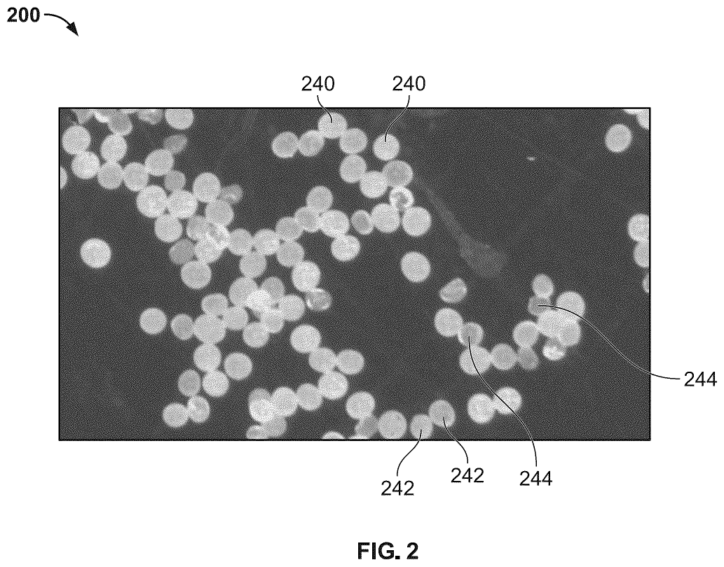

FIG. 2 illustrates an example image 200 of multiple grains of pollen as captured, for example, by the pollen imaging apparatus 106. The grains of pollen are shown against a black acrylic platform (e.g., platform 110, etc.), in this example, where the different classes of pollen are present including, for example, good pollen grains 240, intermediate pollen grains 242, and bad pollen grains 244. As shown in the image 200, the shape of the pollen grains is apparent and instructive of the class of the pollen, and the coloring of the pollen grains is also instructive of the class of the pollen.

That said, it should be appreciated that rather than three classes of pollen, a different number of classes may be used to distinguish pollen grains, including, for example, two classes (e.g., good and bad, etc.), or four classes, or more, etc. It should also be appreciated that the shape of the pollen, and more specifically, the three-dimensional shape of the pollen, or sphericity, may be instructive of the viability of the pollen to germinate. That is, the two dimensional view of pollen grain may indicate one class, while a three-dimensional view of the same pollen grain may reveal dehydration and/or asymmetric shape, etc. In connection therewith, some example embodiments the image capture device 118 may include multiple camera inputs where each is configured to capture a different type of image of the pollen (e.g., a collar image, a two-dimensional image, a three-dimensional image, an IR image, etc.).

Further to the above, the system 100 includes a database 120 of images of pollen in various conditions, where the pollen exhibits characteristics of the three classes of pollen utilized in this example. The database 120, in this manner, may include hundreds of thousands, or more or less, etc., images of the pollen (e.g., 800 images, 1,000 images, 10,000 images, 100,000 images, more than 100,000 images, etc.). In addition to the images, the database 120 includes class designations for the pollen (e.g., for each of the pollen grains, etc.) included in the images, whereby the database 120 includes a division of the images between a training set for the classifier used by the computing device 108 and a validation set for validating the classifier. In other example embodiments, the database 120 of images may include images of pollen in various conditions, where the pollen may exhibit characteristics of less than three or more than three classes of pollen depending, for example, on a number of such classes used in categorizing the pollen, etc.

In this example embodiment, the database 120 (and/or a computing device associated with the database 120) is configured to employ a RetinaNet architecture 122 as an object detection model for pollen in the different classes. In general, the RetinaNet architecture 122 is a composite network that, in this example, generally includes a backbone network in combination with two subnetworks. The backbone network then includes, in general, a bottom-up pathway, a residual neural network (ResNet) with a top down pathway and lateral connections, and a Feature Pyramid Network (FPN). And, the subnetworks (or detection backend) include a first subnetwork configured for object classification and a second subnetwork configured for object regression.

In particular in this example embodiment, with additional reference to FIG. 1B, the example RetinaNet architecture 122 includes ResNet 124 (e.g., ResNet-50 that is fifty layers deep, etc.) and FPN 126 as a basis for feature extraction, and two task-specific subnetworks 128 and 130, at each level of the FPN 126, configured for classification of the pollen in the classes noted above and for bounding box regression. The FPN 126 is further configured to compute the convolutional feature map for the entire image (e.g., from the training set of images captured by an apparatus consistent with the pollen imaging apparatus 106 (be it the apparatus 106 or another similar apparatus), etc.) and the ResNet 124 is configured as a convolutional network (for feature extraction). The first subnetwork 128 (at each level of the FPN 126) is configured to detect objects (e.g., pollen in this example) in the image, and the second subnetwork 130 (at each level of the FPN 126) is configured to append bounding boxes to the detected objects.

In connection therewith, in this example embodiment the RetinaNet architecture 122 uses the FPN 126, generally, as the backbone of the model, and which is built on top of the ResNet 124 in a fully convolutional fashion. The fully convolutional feature of the RetinaNet architecture 122, then, enables the system 100 to input an image, from the imaging apparatus 106, of any arbitrary shape and output proportionally sized feature maps at different levels of the feature pyramid of the FPN 126 (e.g., levels P3, P4, P5, P6, P7, etc. as illustrated in FIG. 1B).

In more detail in this example, the ResNet 124 includes a series of convolutional layers, Res1 to Res5, each at generally different resolutions (e.g., ½, ¼, ⅛, 1/16, 1/32, etc.). The first layer Res1 is implemented upon receipt of an image from the imaging apparatus 106. The first layer in the ResNet 124, for instance, does 3×3 convolution with batch normalization. In doing so, a stride of 1 and a padding of “same” may be used so that the input image gets completely covered by the filter and the specified stride. Since the levels of the pyramid of the FPN 126 are of different scales (or resolutions, etc.), multi-scale anchors are not utilized in this example on a given/specific level. The anchors are defined to have sizes of [32, 54, 128, 256, 412] on levels P3, P4, P5, P6, P7, respectively, of the FPN 126 and also to have multiple aspect ratios [1:1, 1:2, 2:1]. As such, in-total in this example, fifteen anchors may be used over the pyramid of the FPN 126 at each location. Anchor boxes outside the images are ignored. Further in this example, the scales of the ground truth boxes are not used to assign them to levels of the pyramid of the FPN 126. Instead, ground-truth boxes are associated with anchors, which have been assigned to the pyramid levels (e.g., levels P3, P4, P5, P6, P7, etc. as illustrated in FIG. 1B). The detection, then, may be considered positive if the Intersection of Union (IoU) is greater than 0.6, and negative it IoU is less than 0.4. The top predictions from all levels are merged and non-maximum suppression with a threshold of 0.5 is applied to yield the final decisions.

With that said, in this example embodiment, instead of the convolutional layers of the ResNet 124 learning an underlying mapping with regard to the pollen, the ResNet 124 is configured to utilize a corresponding residual mapping. In doing so, as generally shown at 132 in FIG. 1B, instead of utilizing H(x) (the initial mapping), the ResNet 124 is configured to fit F(x)=H(x)−x, which then provides H(x)=F(x)+x. This provides a skip connection among the convolutional layers, so that if any layer negatively impacts performance of the RetinaNet architecture 122, overall, that layer may be skipped by regularization. Thus, through this configuration, the ResNet 124 may result in training of the RetinaNet architecture 122 while inhibiting potential concerns, negative impacts, etc. that may arise by vanishing/exploding gradients.

The FPN 126 may be configured, in general, consistent with an image pyramid, each at a different convolutional layer of the ResNet 124 (e.g., each at convolutional layers Res3, Res4, Res5, etc.), whereby a scale may be defined between the different layers of the pyramid. Feature detection, therefore, may be imposed at the different levels of the pyramid. In the illustrated embodiment, the FPN 126 includes five levels of the pyramid, for instance, P3 (having ⅛ resolution), P4 (having 1/16 resolution), P5 (having 1/32 resolution), P6 (having 1/64 resolution, and P6 (having 1/128 resolution). In connection therewith, P1 has resolution 21 lower than the input image.

More particularly in this example, as shown in FIG. 1B, the FPN 126 generally provides a top-down pathway (e.g., M5 through M3 having resolutions of 1/32, 1/16, ⅛, etc.), in connection with the five levels of the pyramid (e.g., P3 through P7, etc.) with lateral connections to the ResNet 124. In this manner, the spatially coarser feature maps from higher pyramid levels may be up-sampled to merge with the bottom layers with the same spatial size. The features at higher levels have relatively smaller resolution but carry stronger semantic information. Higher level features may also be more suitable for detecting larger objects. While, at the other end, grid cells from lower-level feature maps have relatively higher resolution and hence may be better at detecting smaller objects. As such, through a combination of the top-down pathway of the FPN 126 and the lateral connections with the bottom up the pathway of the ResNet 124, which may not require much extra computation, each level of the resulting feature maps may be both semantically and spatially strong.

In connection with using the image pyramid of the FPN 126, in general each image is subsampled into several different resolutions. Feature maps may therefore be calculated for all the different resolutions. As such, in this example, instead of just using the final feature map(s), the RetinaNet architecture 122 takes feature maps before every pooling/subsampling layer. The same operations are performed on each of these feature maps and finally combined using non-maxima suppression.

With continued reference to FIG. 1B, as generally described above, the first subnetwork 128 (at each layer of the FPN 126) is configured to detect objects (e.g., pollen, etc.) for use in classification of the detected objects. More particularly in this example, the first subnetwork 128 (or classification subnet in this example) is connected to each level of the FPN 126 for object classification. In the illustrated embodiment, the first subnetwork 128 includes 3×3 convolutional layers with 256 filters followed by another 3×3 convolutional layer with K×A filters. Therefore, the generated output feature map (from each level of the FPN 126) would be of size W×H×KA where W and H are proportional to the width and height of the input feature map and K and A are the numbers of object classes and anchor boxes respectively. In connection therewith, a sigmoid layer may be used for object classification. In addition, a prior probability of about 0.01 may be used for all anchor boxes in connection with the last convolutional layer of the first subnetwork 128

The second subnetwork 130 (at each layer of the FPN 126), then, is configured to apply bounding boxes to the detected objects (e.g., to each grain of pollen detected in the image, etc.), for example, for use in object regression. In particular in this example, the second subnetwork 130 (or regression subnet) is attached to each feature map of the FPN 126, in parallel to the first subnetwork 130. The configuration of the first subnetwork 130 is substantially similar to the first subnetwork 128, with the exception that a last convolutional layer includes a 3×3 convolution layer with 4A filters, resulting in an output feature map of size W×H×4A. In connection therewith, the last convolutional layer has 4 filters because, in order to localize the class objects, the regression subnet produces 4 numbers for each anchor box that predicts the relative offset in terms of center co-ordinates, width and height, between the anchor box and the ground truth box. Thus, unlike other available detectors (e.g., R-CNN, Fast R-CNN, etc.), the RetinaNet architecture 122 provided herein, through use of the bounding box regression, may be class-agnostic, and therefore may lead to generally reduced (or fewer) parameters but still provided effective output (e.g., comparable to that of the other available detectors, etc.).

In some example embodiments, in addition to (or in connection with) application of the RetinaNet architecture 122 described herein, the database 120 (and/or computing device associated with the database 120) may be configured to implement a focal loss (FL) feature. The FL feature, generally, is associated with Cross-Entropy (CE) Loss, which generally is configured to penalize wrong predictions more than to reward correct predictions. In connection therewith, FL is configured to handle and/or address class imbalances by assigning more weights to relatively difficult (or hard) objects to classify or easily misclassified objects (e.g., background objects with noisy texture or partial objects, objects of interest, etc.) and to down-weight more easily classified objects or objects that are relatively easier to classify (e.g., certain background objects, etc.). The FL feature thus may be viewed as an extension of CE loss (and associated cross-entropy loss function) that, through such down-weighting of relatively easily classified objects, generally focusses training on relatively harder negatives.

Taking into account the above, then, FL may be defined by way of Equation (1):

FL(pₜ)=−αₜ(1−pₜ)^{γ} log log(pₜ) (1)

In Equation (1), pₜ represents a probability of a ground truth class, γ represents a focusing parameter, and α represents a balancing parameter. In connection therewith, for instance, when γ=0, FL is equivalent to CE. However, as the value of γ increases, FL and CE then deviate. As such, through Equation (1) above, FL may be used to handle and/or address class imbalances by assigning more weight, via the balancing parameter (α), to down-weight more easily classified objects or objects that are relatively easier to classify (e.g., certain background objects, etc.) and focus training on harder classified objects (or hard negatives) (e.g., to inhibit (or avoid) small losses that, summed over an entire image, may overwhelm the overall loss; etc.).

Once the classifier, as defined by the RetinaNet architecture 122, is compiled, trained and validated, by the database 120, the database 120 is configured to then deploy the classifier to the computing device 108, and other similar computing devices for use as described below.

Then in this example embodiment, upon receipt of an image of pollen 112 from the pollen imaging apparatus 106, the computing device 108 is configured to employ the deployed classifier, whereby each distinct grain of pollen is classified as either good, intermediate or bad (in this example). In addition, the computing device 108 is configured to count the number of pollen grains in the image, and to determine percentages, averages, etc., between the classified pollen and the total number of pollen grains in this image, and then to compare the different classes of pollen grains to one or more thresholds. Finally, the computing device 108 is configured to present an output indicative of a result of the comparison, or merely the counts, averages, percentages, etc.

In one example, the computing device 108 may be configured to determine that 73% of the pollen in an image is good, which may satisfy a threshold of 70%. As such, the computing device 108 may be configured to display a pass indication (e.g., a green checkmark, a PASS indication, etc.), to indicate to the user 104 that the pollen included in the image, as captured at the pollen imaging apparatus 106, is viable for use in a pollination experiment.

In some example embodiments, the user 104 may provide multiple different samples of the collected pollen to the pollen imaging apparatus (e.g., three different samples each having between about 100 pollen grains about 300 pollen grains, etc.), and perform the above analysis on each of the different samples. In connection therewith, the computing device 108 may be configured to display a pass indication (or not) for each of the different samples. Or, the computing device 108 may be configured to analyze the images for the different samples together, and the display a single pass indication (or not) for the combination of the different samples.

Thereafter, the user 104 is permitted to use, heed, etc. the output of the computing device 108, and proceed accordingly, for example, by pollinating corn silk of a corn plant (where the plant 102 is a corn plant), or other plant as appropriate for the particular experiment, type of pollen, etc.

While only one pollen imaging apparatus 106, one computing device 108, and one database 120 are illustrated in the system 100, it should be appreciated that additional ones of these parts may be included in other system embodiments.

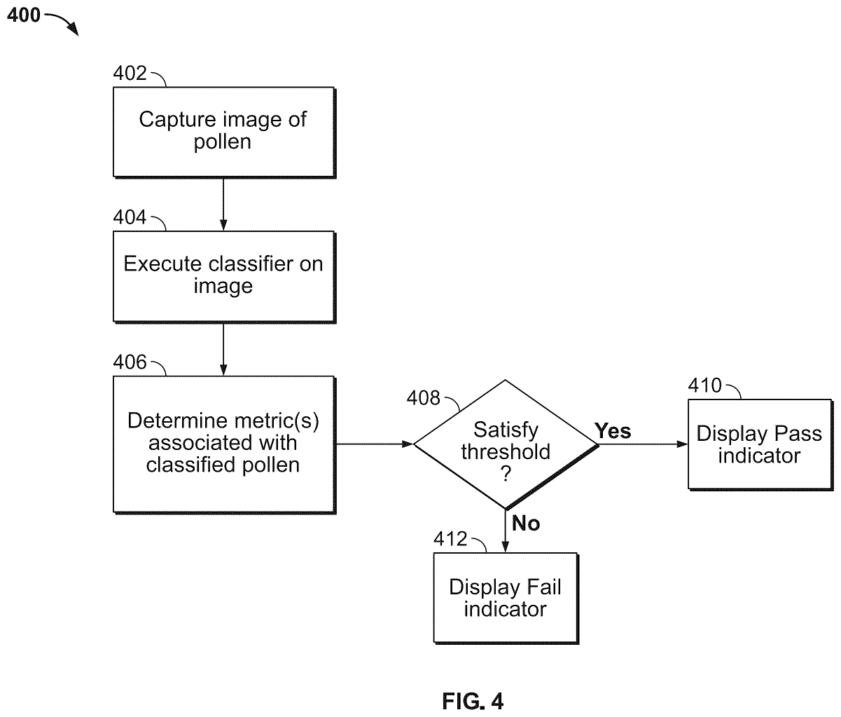

FIG. 4 illustrates an example computing device 300 that may be used in the system 100 of FIG. 1. The computing device 300 may include, for example, one or more servers, workstations, personal computers, laptops, tablets, smartphones, etc. In addition, the computing device 300 may include a single computing device, or it may include multiple computing devices located in close proximity or distributed over a geographic region, so long as the computing devices are specifically configured to function as described herein. In the example embodiment of FIG. 1, each of the pollen imaging apparatus 106, the computing device 108 and the database 120 includes, or is implemented in, a computing device similar to and/or consistent with the computing device 300. However, the system 100 should not be considered to be limited to the computing device 300, as described below, as different computing devices and/or arrangements of computing devices may be used in other embodiments. In addition, different components and/or arrangements of components may be used in other computing devices.

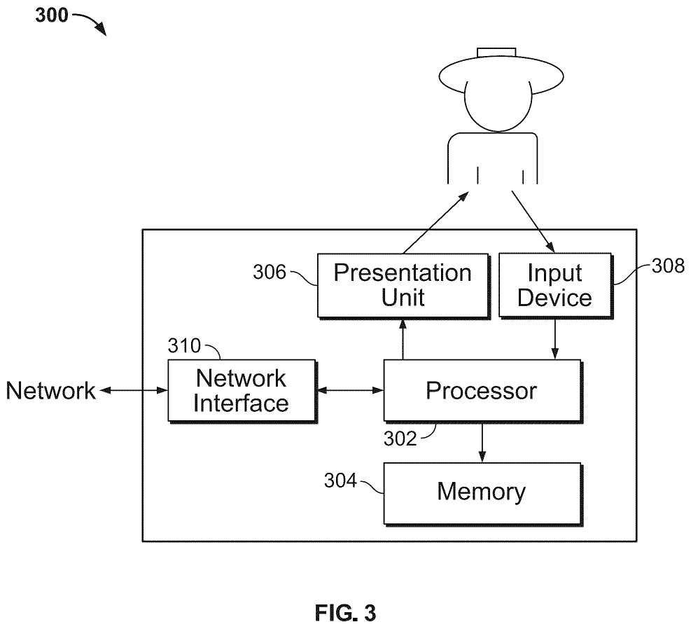

Referring to FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, images, classifiers, datasets, and/or other types of data (and/or data structures) suitable for use as described herein.

Furthermore, in various embodiments, computer-executable instructions may be stored in the memory 304 for execution by the processor 302 to cause the processor 302 to perform one or more of the functions described herein (e.g., one or more of the operations of method 300, etc.), such that the memory 304 is a physical, tangible, and non-transitory computer readable storage media. Such instructions often improve the efficiencies and/or performance of the processor 302 and/or other computer system components configured to perform one or more of the various operations herein, whereby upon performing such operations the computing device 300 may be transformed into a special-purpose computing device configured specifically (via such operations) to evaluate pollen quality. It should be appreciated that the memory 304 may include a variety of different memories, each implemented in one or more of the functions or processes described herein.

In the example embodiment, the computing device 300 also includes a presentation unit 306 that is coupled to (and is in communication with) the processor 302 (however, it should be appreciated that the computing device 300 could include output devices other than the presentation unit 306, etc.). The presentation unit 306 outputs information, visually or audibly, for example, to a user of the computing device 300 (e.g., results of a classification of a pollen image, etc.), etc. And various interfaces may be displayed at computing device 300, and in particular at presentation unit 306, to display certain information in connection therewith. The presentation unit 306 may include, without limitation, a liquid crystal display (LCD), a light-emitting diode (LED) display, an organic LED (OLED) display, an “electronic ink” display, speakers, etc. In some embodiments, the presentation unit 306 may include multiple devices.

In addition, the computing device 300 includes an input device 308 that receives inputs from the user (i.e., user inputs) of the computing device 300 such as, for example, inputs to capture an image of pollen, as further described below. The input device 308 may include a single input device or multiple input devices. The input device 308 is coupled to (and is in communication with) the processor 302 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 306 and an input device 308.

Further, the illustrated computing device 300 also includes a network interface 310 coupled to (and in communication with) the processor 302 and the memory 304. The network interface 310 may include, without limitation, a wired network adapter, a wireless network adapter (e.g., an NFC adapter, a Bluetooth™ adapter, etc.), a mobile network adapter, or other device capable of communicating to one or more different ones of the networks herein and/or with other devices described herein. Further, in some example embodiments, the computing device 300 may include the processor 302 and one or more network interfaces incorporated into or with the processor 302.

FIG. 5 illustrates an example method 400 for use in determining viability of pollen (broadly, for use in evaluating pollen quality), through image processing, prior to use of the pollen in a pollination process. The example method 400 is described as implemented in the system 100. Reference is also made to the computing device 300. However, the methods herein should not be understood to be limited to the system 100 or the computing device 300, as the methods may be implemented in other systems and/or computing devices. Likewise, the systems and the computing devices herein should not be understood to be limited to the example method 400.

At the outset in the method 400, the user 104 uses the pollen imaging apparatus 106 to capture an image of the pollen 112, at 402. In particular, the user 104 collects pollen from the plant 102, for example, by use of a paper cone or other instrument suitable for the particular plant 102. It should be appreciated that while in this example pollen is described as collected directly from the plant 102, the pollen may be collected or received from other sources, such as, for example, other users, various plants (or combinations of plants), and potentially, one or more storage locations (e.g., collected from prior plants, or season/specimen of plants, etc.), etc. In short, the pollen is available for use in pollination of one or more plants, whereby an assessment of the pollen's viability (broadly, quality) may be desired, or necessary, prior to such use or in connection with such use, etc.

In connection therewith, regardless of how or from where the pollen 112 is received or collected, the user 104 disposes the pollen on the platform 110 of the pollen imaging apparatus 106. The pollen 112 provided to the pollen imaging apparatus 106, and positioned on the platform 110, may include all of the pollen collected from the plant 102, or it may include a representative sample thereof (or multiple representative samples thereof).

As explained above, the platform 100 is structured to hold the pollen 112, and the user 104 spreads the pollen on the platform 110 to avoid clumps, overlapping grains of the pollen 112, etc. (e.g., such that the grains of the pollen 112 are arranged in a generally single layer on the platform 110, etc.) The platform 110 is also colored or otherwise configured to provide contrast to the pollen 112. The platform 110 and the enclosure 114 are engaged to limit or eliminate ambient light to the pollen 112, and then, the light fixture 116 and the image capture device 118 cooperate to capture an image (or multiple images) of the pollen 112. The pollen imaging apparatus 106 may capture the image in response to a user input to the pollen imaging apparatus 106 and/or the computing device 108, or in response to another detected condition that the pollen 112 is position on the platform 110 and in the enclosure 114 and is ready to be imaged.

In turn, the captured image(s) of the pollen is transmitted to the computing device 108, via a wired or wireless communication connection (e.g., as generally described above in the system 100, etc.).

Next in the method 400, at 404, in response to receipt of the captured image(s), the computing device 108 executes the classifier on the captured image(s). In particular, the classifier is compiled as described above in the system 100 (through training, etc.), and then the image(s), is(are) processed accordingly to the classifier. In connection therewith, the image(s) is(are) convoluted into multiple layers, consistent with the training of the classifier, and then extracted features are used as inputs to the subnetworks 128 and 130, which define the specific class of the grains of the pollen 112 included in the image(s). The output from the classifier includes a count of the grains of pollen 112 in the image(s), and a count for each of the classes of the pollen 112 in the image(s).

The computing device 108 then determines, at 406, one or more metrics associated with the classified pollen. The pollen classes may be used alone, or in combination. For example, a percentage of the bad pollen grains (as compared to the good and intermediate pollen grains) may be determined (as a metric), or a percentage for each of the good, intermediate and bad pollen grains may be determined (as a metric). Other metrics may relate to size of pollen grains, shape of pollen grains, color of pollen grains, contrast of pollen grains, roundness of pollen grains, etc.

At 408, the computing device 108 determines whether one or more thresholds is satisfied by the determined one or more metrics. For example, the user 104, or another user, may require no more than 10% of the pollen 112 to be classified as bad pollen in order for the pollen 112 to be available for a particular use. In such an example, the computing device 108 determines, without limitation, whether the number of (or whether the metric for) good pollen grains in the image is above or below the certain threshold, or whether the number of or metric for bad pollen grains in the image is above or below the certain threshold, etc. When the threshold is satisfied, for example, the computing device 108 displays, at 410, a pass or positive indicator to the user 104 (e.g., at the presentation unit 306 of the computing device 108, etc.). Conversely, when the threshold is not satisfied, the computing device 108 displays, at 412, a fail or other negative indicator to the user 104 (e.g., at the presentation unit 306 of the computing device 108, etc.).

The user 104 may then rely on the indicator, at the presentation unit 306 of the computing device 108, for example, and proceed in one or more pollination processes with (or other uses for) the pollen 112, when it passes, and to discard the pollen 112 when the pollen 112 fails. In particular, when the pollen 112 passes, the user 104 may apply the pollen to a plant to be pollinated, thereby ascertaining and confirming the viability of the pollen prior to the pollination.

In this example embodiment, the computing device 108 performs the image processing operations, for example, locally at the computing device 108. In other example embodiments, the imaging processing operations may be performed away from the computing device 108, for example, at a remote server or cloud-based server, whereby the computing device 108 communicates the images to/with the remoter server or cloud-based server and then receives the results of the analysis therefrom. Further, in still other example embodiments, the imaging apparatus 106 may be configured to perform the imaging processing operations described herein. For instance, in at least one such embodiment, the imaging apparatus 106 may include at least one processor (e.g., processor 302 of computing device 300, etc.) configured to: (a) in response to capturing the image(s) of the pollen (at 402), executes the classifier on the captured image(s) (e.g., in generally the same manner as described at operation 404, etc.); (b) determine one or more metrics associated with the classified pollen (e.g., in generally the same manner as described at operation 406, etc.); (c) determine whether one or more thresholds is satisfied by the determined one or more metrics (e.g., in generally the same manner as described at operation 408, etc.); (d) when the threshold is satisfied, display a pass or positive indicator to the user 104 (e.g., in generally the same manner as described at operation 410, etc.); and (e) when the threshold is not satisfied, display a fail or other negative indicator to the user 104 (e.g., in generally the same manner as described at operation 412, etc.).

### Example

The following example is exemplary in nature. Variations of the following example are possible without departing from the scope of the disclosure.

In connection with an example training phase of the present disclosure, for example, as part of training the RetinaNet architecture 122, the database 120 (and/or computing device associated with the database 120) identified and/or was provided a training dataset of 800 images of pollen collected over a period of two years (e.g., from two greenhouses, etc.). The images each had a size of 1280 pixels by 720 pixels.

In this example, a model was constructed (or built or generated, etc.) based on a pretrained ResNet-50 model using the Coco dataset. The backbone layers, then, were frozen to account for the relatively smaller size of the training data set in this example, of 800 images (e.g., to help inhibit overfitting, etc.). And, ‘random-transform’ was used to randomly transform the training dataset to get data augmentation. Then, using a batch-size of 8, the model was trained for 300 epochs, with 20 steps per epoch, using about 200 randomly selected images from the training dataset. The model was then re-trained with an additional about 200 different images, which were obtained at a later time. At both stages of training, an 80-20 split between training and validation sets was used.

In view of the above, the systems and methods herein provide for enhanced assessment of pollen (e.g., of pollen quality, etc.), for example, in the course of a pollination process, whereby viability of the pollen may be assessed prior to proceeding with pollination. In particular, image analysis is employed to assess the pollen beyond a two-dimensional shape of grains of the pollen, whereby the three-dimensional representation, or sphericity of the grains of the pollen (e.g., through coloring of the pollen, etc.) is understood, and a more complete assessment of the pollen is permitted. In this manner, the image analysis, via classification based on images, provides an objective assessment of viability of the pollen (e.g., reducing need for skilled users and/or subjective inspection of the pollen, etc.), which is generally independent of a time of day, environmental parameters (e.g., temperature, relative humidity, light, etc.), plant materials, seasons, etc. As such, a fast, mobile, objective assessment of viability of pollen is provided herein.

In addition, use of the RetinaNet architecture herein provides a one-stage objection detection model for objects (e.g., pollen grains, etc.) that are closely situated, dense, and/or small in size. Further, the inclusion of the FPN and the ResNet in the RetinaNet herein provides relatively high detection rates of pollen grains in the samples provided to the imaging apparatus, at relatively high accuracy and speed, for example, as compared to other detectors. What's more, through use of RetinaNet herein, and the FPN, pollen detection may be provided at multiple scales with reduction in extreme foreground-background class imbalance (e.g., through application of a Focal loss function, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) capturing, by a pollen imaging apparatus, an image of pollen disposed on a platform of the pollen imaging apparatus; (b) classifying pollen included in the captured image into one of multiple classes, based on a classifier defining a feature pyramid network; (c) determining one or more metrics associated with the one or more classes of pollen included in the image; (d) providing, to a user, an indication of viability of the pollen based on whether the one or more metrics satisfy a defined threshold, thereby instructing the user in the viability of the pollen included in the image; and (e) lighting, by a light fixture of the pollen imaging apparatus, the pollen when capturing the image of the pollen.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in determining viability of pollen, through image processing, the method comprising:
capturing, by a pollen imaging apparatus, an image of pollen disposed on a platform of the pollen imaging apparatus;
classifying, by a computing device, coupled to the pollen imaging apparatus, pollen included in the captured image into one of multiple classes, based on a classifier defining a feature pyramid network;
determining, by the computing device, one or more metrics associated with the one or more classes of pollen included in the image; and
providing, by the computing device, to a user, an indication of viability of the pollen based on whether the one or more metrics satisfy a defined threshold, thereby instructing the user in the viability of the pollen included in the image.

2. The computer-implemented method of claim 1, wherein the pollen imaging apparatus includes an enclosure, which cooperates with the platform to inhibit ambient light from the pollen; and
wherein the method further comprises lighting, by a light fixture, the pollen when capturing the image of the pollen.

3. The computer-implemented method of claim 1, wherein the classifier defines a RetinaNet architecture including the feature pyramid network and a residual neural network, and wherein the residual neural network includes a convolutional network.

4. The computer-implemented method of claim 1, wherein the one or more classes of pollen includes a good class and a bad class; and
wherein the one or more metrics includes a percentage of the pollen included in the image classified in one of the good class and the bad class.

5. The computer-implemented method of claim 1, wherein providing the indication of viability includes displaying, at a presentation unit of the computing device, a pass or fail indicator to the user based on whether the one or more metrics satisfies the defined threshold.

6. The computer-implemented method of claim 1, wherein the computing device includes a portable computing device associated with the user; and/or
wherein the platform defines an acrylic, black surface.

7. A non-transitory computer-readable storage medium including executable instructions for determining viability of pollen, which when executed by at least one processor, cause the at least one processor to:
receive at least one image of pollen from a pollen imaging apparatus, whereby the at least one image includes an image of the pollen disposed on a platform of the pollen imaging apparatus;
classify pollen included in the received at least one image into one of multiple classes, based on a classifier defining a feature pyramid network;
determine one or more metrics associated with the one or more classes of pollen included in the at least one image; and
provide, to a user, an indication of viability of the pollen based on whether the one or more metrics satisfy a defined threshold, thereby instructing the user in the viability of the pollen included in the at least one image.

8. The non-transitory computer-readable storage medium of claim 7, wherein the classifier defines a RetinaNet architecture including the feature pyramid network and a residual neural network, and wherein the residual neural network includes a convolutional network.

9. The non-transitory computer-readable storage medium of claim 7, wherein the one or more classes of pollen includes a good class and a bad class; and
wherein the one or more metrics includes a percentage of the pollen included in the at least one image classified in one of the good class and the bad class.

10. The non-transitory computer-readable storage medium of claim 7, wherein the executable instructions, when executed by the at least one processor to provide the indication of viability, cause the at least one processor to display a pass or fail indicator to the user, at a presentation unit of a portable communication device including the at least one processor, based on whether the one or more metrics satisfies the defined threshold.

11. A system for use in determining viability of pollen, through image processing, the system comprising at least one computing device configured to:
receive an image of pollen from a pollen imaging apparatus, whereby the image includes an image of the pollen disposed on a platform of the pollen imaging apparatus;
classify pollen included in the received image into one of multiple classes, based on a classifier defining a feature pyramid network;
determine one or more metrics associated with the one or more classes of pollen included in the image; and
provide, to a user, an indication of viability of the pollen based on whether the one or more metrics satisfy a defined threshold, thereby instructing the user in the viability of the pollen included in the image.

12. The system of claim 11, wherein the classifier defines a RetinaNet architecture including the feature pyramid network and a residual neural network, and wherein the residual neural network includes a convolutional network.

13. The system of claim 11, wherein the one or more classes of pollen includes a good class and a bad class; and
wherein the one or more metrics includes a percentage of the pollen included in the image classified in one of the good class and the bad class.

14. The system of claim 11, wherein the at least one computing device includes a presentation unit; and
wherein the at least one computing device is configured, in order to provide the indication of viability, to display, at the presentation unit, a pass or fail indicator to the user based on whether the one or more metrics satisfies the defined threshold.

15. The system of claim 11, wherein the at least one computing device includes a portable computing device associated with the user.

16. The system of claim 11, further comprising the pollen imaging apparatus;
wherein the pollen imaging apparatus is configured to:
capture the image of the pollen disposed on the platform of the pollen imaging apparatus; and
transmit the image to the at least one computing device.

17. The system of claim 16, wherein the pollen imaging apparatus further includes the platform and an enclosure, which cooperates with the platform to inhibit ambient light from the pollen disposed on the platform.

18. The system of claim 16, wherein the pollen imaging apparatus further includes an image capture device configured to capture the image of the pollen disposed on the platform of the pollen imaging apparatus.

19. The system of claim 16, wherein the pollen imaging apparatus further includes a light fixture configured to illuminate the pollen on the platform of the pollen imaging apparatus, when the image capture device captures the image of the pollen.

20. The system of claim 16, wherein the platform defines an acrylic, black surface.

21. A pollen imaging apparatus for use in determining viability of pollen, through image processing, the pollen imaging apparatus comprising:
a platform configured to support pollen in the pollen imaging apparatus;
an enclosure configured to cooperate with the platform to inhibit ambient light from the pollen disposed on the platform;
an image capture device configured to capture the image of the pollen disposed on the platform of the pollen imaging apparatus;
a light fixture configured to illuminate the pollen on the platform of the pollen imaging apparatus, when the image capture device captures the image of the pollen; and
a network interface configured to receive instructions for capturing the image and/or configured to transmit the captured image to at least one computing device.

22. The pollen imaging apparatus of claim 21, wherein the platform defines an acrylic, black surface.

23. The pollen imaging apparatus of claim 21, further comprising at least one processor configured to:
classify pollen included in the captured image into one of multiple classes, based on a classifier defining a feature pyramid network;
determine one or more metrics associated with the one or more classes of pollen included in the image; and
provide, to a user, via the network interface, an indication of viability of the pollen based on whether the one or more metrics satisfy a defined threshold, thereby instructing the user in the viability of the pollen included in the image.

24. The pollen imaging apparatus of claim 21, wherein the image capture device includes a portable image capture device.
